(19) United States
(12) Patent Application Publication
(10) Pub. No.: US 2012/0089058 A1
(43) Pub. Date: Apr. 12, 2012

(54) EXERCISE GARMENT WITH LOCALIZED MASSAGE FEATURE

(75) Inventor: Stanley W. Ellis, Bakersfield, CA (US)

(73) Assignee: ELLIS ENERGY INVESTMENTS, Bakersfield, CA (US)

(21) Appl. No.: 12/902,981

(22) Filed: Oct. 12, 2010

(51) Int. Cl. A61H 7/00

(52) U.S. Cl. 601/134

(57) ABSTRACT

An exercise garment of elastic material is constructed with embedded rigid balls to provide a localized massage to the wearer during exercise.

### BACKGROUND OF THE INVENTION

Massage therapy has long been used for remedial or hygienic treatments of the human body by relaxing and stretching tight muscles, improving circulation, increasing range of motion, freeing trapped nerves, and relieving muscle spasm. Massage combined with negative pressure, for example, has been found to increase localized circulation, which has been particularly useful in the treatment of cellulite. Negative pressure, of course, requires a vacuum source and means to apply it to the localized area, and when massage and negative pressure are applied simultaneously the massage is typically mechanized, such as by the use of motorized or mechanically activated rollers. Massage has also been combined with a variety of energy sources of a non-mechanical nature, such as pulsed semiconductor lasers, infrared light, and radiofrequency energy. Therapies have also utilized electrolipophoresis, in which a low-frequency electromagnetic field is created by the insertion of several pairs of needles into the region to be treated, and some therapies have used non-invasive ultrasound. Pharmaceutical treatments known as mesotherapy have also been used, including various vitamins, antifibrotics, lypolitics, and anti-inflammatories.

Most of these are impractical, if not out of economic reach, for the typical individual who simply seeks to improve his or her appearance. The present invention seeks to address cellulite and related issues such as the removal of localized fat deposits, improvements in localized muscle toning, and the general control of one's figure, by non-invasive and non-chemical means. The means of achieving these and other objects and advantages of the invention, as well as the features of the invention in its various embodiments, will be apparent from the descriptions that follow.

### SUMMARY OF THE INVENTION

The present invention resides in an exercise garment that imparts localized massage to the user as a result of the movement of the user. Features of the garment include embedded rigid balls in elasticized compartments that move against the surface of the user's body when the garment stretches or relaxes, either during exercise, stretching, simple breathing, or any movement of the user that causes the elastic garment to expand or contract. The garment preferably contains no additional compressive or motion-imparting components other than the balls themselves and the garment material, and the balls can serve their function in a non-rotating manner. The garment is adaptable for use on any body part that the garment can be placed around, and the sizes, numbers, and locations of the balls can be selected to optimize their use on the sizes of particular individuals, on the sizes of their body parts, or on particular physiological conditions.

### BRIEF DESCRIPTION OF THE DRAWINGS

FIG. 1 is a perspective view of an exercise belt within the scope of the present invention.

FIG. 2 depicts the belt of FIG. 1 laid out flat.

FIG. 3 depicts one segment of the belt of the preceding Figures with a portion of the fabric on the inner side of the belt removed to reveal the internal compartments and the balls retained in the compartments.

FIG. 4 is a perspective view of a pair of bicycle shorts within the scope of the present invention.

### DETAILED DESCRIPTION OF THE INVENTION AND ILLUSTRATIVE EMBODIMENTS

The term “garment” is used herein to include anything worn by the user, such as shorts, undergarments, pants, a shirt, or a belt. The term “belt” is used herein to include devices that form a loop that can encircle the waist of the user or other parts of the user's body such as legs, arms, and hips. The material from which garments within the scope of the invention are made is a flexible material that is easily wrapped around or that encases the body part to be treated, and that can be wound over itself if desired to encircle a relatively small body part such as an upper arm while also be useful for the waist. The material from which the garment is made is elastic so that it can be tightly wrapped over the body part and so that once secured, it can be stretched as the muscles of the user expand or as the user breathes. Although the balls will add weight to the garment, the garment itself can be weighted by additional means for a further weight training effect, particularly exercise belts. Exercise belts can also provide a certain degree of stiffness, preferably in one direction with the other directions remaining elastic. The stiffness can provide the typical support that is frequently needed during weight training and other types of exercise. The garments in general are preferably made of a woven fabric with an elastic construction, or blend of a rubberized material and a woven fabric.

Included in the garment are compartments to contain the rigid balls. The compartments can be enclosed pockets sewn into the garment, or pockets with closures that can be opened and closed by the user to allow the insertion, removal, or exchange of balls. Any conventional closure, such as buttons, snaps, or VELCRO® hook-and-loop-type fasteners, can be used. The thickness of the panel on the inner sides of the compartments will be thin enough that the balls exert a localized pressure through the panel, a pressure that will travel along the user's body surface as the garment stretches and contracts. The outer sides of the compartments can be thicker, and can provide the greater contribution to the elasticity and integrity of the garment. Thus, the two panels may be made of different materials, such as for example a neoprene/polyester blend for the outer panel and polyester for the inner panel. The compartments are also preferably small enough that the balls move within the compartments by at most a minimal amount as the garment changes shape. Thus, certain embodiments of the invention will have compartments that accommodate a single ball per compartment, and other embodiments will have compartments that accommodate two or more balls per compartment. In a preferred construction, the compartments are elongated yet narrow enough to accommodate a single row of balls and to retain the balls in the single-file configuration. The number of balls in a single row can vary widely, depending on need and preference, as well as on the sizes of the balls and of the garment. For example, a single row can contain from 5 to 30 balls. Marble-size balls in an exercise belt might be 10-15 per row.

Belts, and particularly exercise belts, that are made in accordance with this invention will generally contain a closure that allows the user to secure the belt to the body part. The closure can take the form of a conventional clasp, such as a buckle, snaps, or buttons, hooks and loops, or the form of a hook-and-loop fastener, such as VELCRO®. Shorts, pants, or undergarments in accordance with this invention will preferably be those that remain in place by their elasticity, with a stretch fit to the user.

The balls can be of any rigid material, examples of which are glass, wood, plastic, and metal, either hollow or solid (continuous). The sizes of the balls can vary and are not critical to the utility of the invention. In most cases, balls with diameters within the range of about 0.5 cm to about 5 cm, and preferably about 1 cm to about 3 cm, will be the most convenient. The weight of each ball can likewise vary, and a convenient weight range might be from about 3.0 g to about 10 g. As one example, balls that are 1.47 cm in diameter and 4.21 g in weight are used.

The garments shown in the attached figures are presented for illustrative purposes.

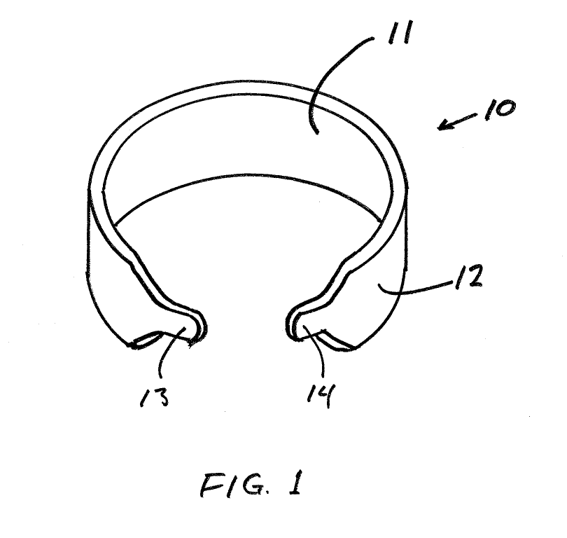

FIG. 1 depicts an exercise belt 10 that is an elongated strip designed to encircle a user's waist. The strip has an inner surface 11 and an outer surface 12, the inner surface contacting the user's body. At the two ends of the belt are closure components 13, 14.

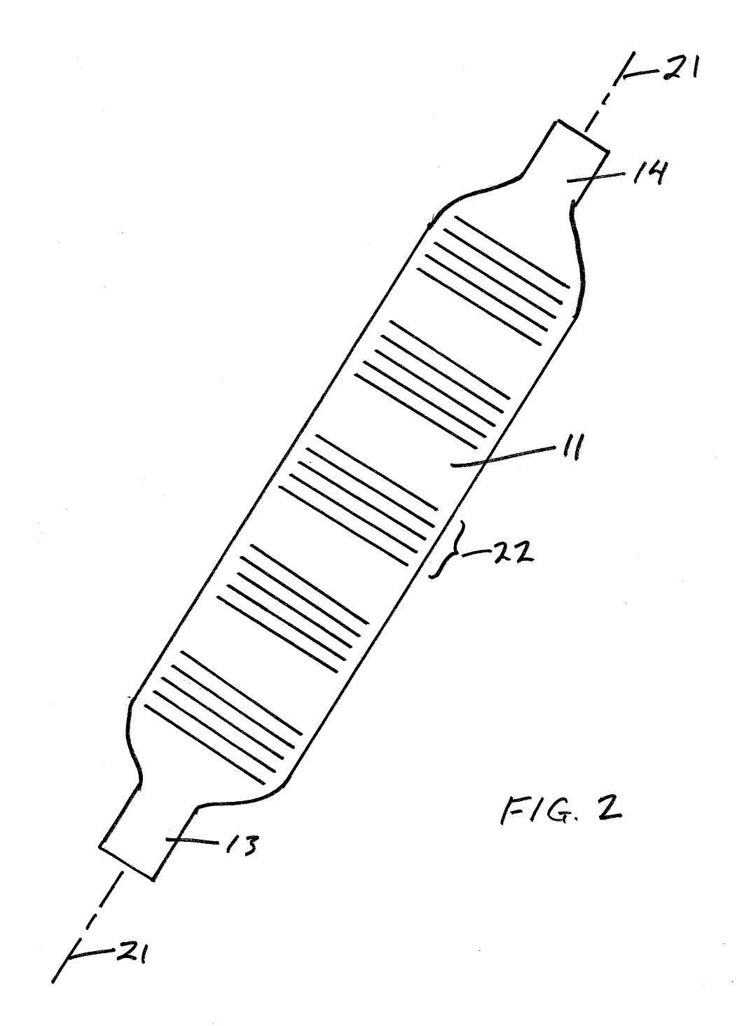

FIG. 2 is a view of the inner surface 11 of the belt with the belt laid out flat. The belt has a longitudinal axis 21 that is parallel to the longitudinal edges of the belt, and the belt is wider at its center than at its ends to provide greater area for muscle and bone support as well as for the massage action. In use, the belt with expand along its longitudinal axis 21 by stretching, and may also twist around this axis or bend away from the straight configuration of the axis, or a combination of these movements. Segments 22 of the belt are ridged with elongated pockets that hold the balls and that run transverse to the belt axis 21. Thus, as the fabric between the segments stretches in response to stresses imposed on the belt as the user moves or breathes, the segments move laterally relative to, i.e., toward and away from, each other, increasing or decreasing the distance between them. Likewise, adjacent pockets within a segment can move relative to each other when the same stresses are applied to the belt, separating and moving back together. While the elongated pockets are grouped in segments in the belt shown, with adjacent segments separated by continuous lengths of material, the pockets in an alternative design can cover the entire length of the expanded portion of the belt with no separating sections.

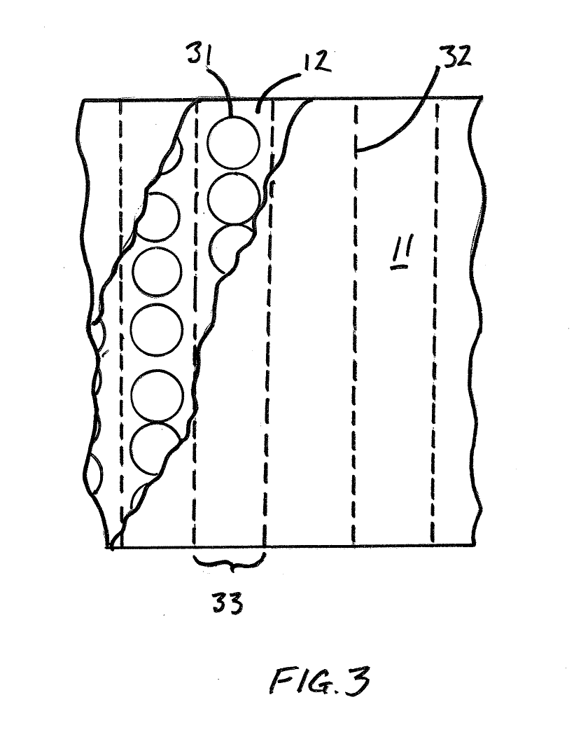

FIG. 3 is a view of one segment of the belt of FIG. 2, showing inner panel 11 of the belt with a portion removed to show both the outer panel 12 and the balls 31 between the panels. Stitching lines 32 join the inner and outer panels and serve as partitions between the compartments 33. Each compartment is only wide enough to accommodate one row of balls, and is filled with enough balls to prevent them from accumulating at one end of the compartment.

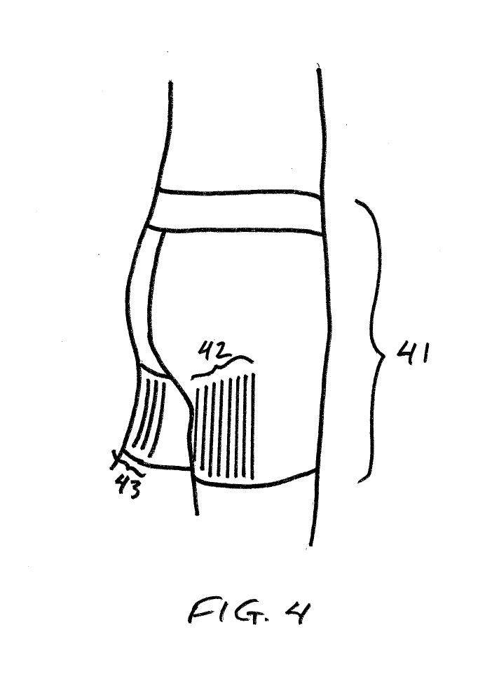

FIG. 4 depicts a pair of exercise or bicycle shorts 41 made of stretch fabric. The shorts contain two series of vertical compartments 42, 43 sewn into the shorts fabric, each compartment containing a single row of balls. One series of compartments and balls is positioned at the back of each thigh portion of the shorts to address the accumulation of cellulite or fatty tissue in those areas or to build muscle tone in these areas. Shorts with compartments and balls in other locations, such as the seat, can fabricated to address those parts of the body that are in contact with those locations.

In the claims appended hereto, the term “a” or “an” is intended to mean “one or more.” The term “comprise” and variations thereof such as “comprises” and “comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein or any prior art in general and an explicit teaching of this specification is intended to be resolved in favor of the teaching in this specification. This includes any discrepancy between an art-understood definition of a word or phrase and a definition explicitly provided in this specification of the same word or phrase.

What is claimed is:

1. An elastic garment constructed to encircle a portion of a user's body, comprising an elastic support member having a plurality of compartments therein, each compartment having an inner wall and an outer wall, with rigid balls retained in said compartments and in direct contact with said inner wall, said inner wall being sufficiently thin that said retained balls impose localized pressure in a massaging movement on said user's body through said inner walls as said portion of said user's body encircled by said garment expands or contracts.

2. The elastic garment of claim 1 wherein said support member is an elongated strip of material having first and second ends, and said elastic garment further comprises means for joining said first and second ends to encircle said portion of said user's body.

3. The elastic garment of claim 1 wherein said support member is an exercise belt.

4. The elastic garment of claim 1 wherein said support member is a pair of exercise shorts.

5. The exercise garment of claim 1 wherein said compartments contain no components other than said rigid balls.

6. The exercise garment of claim 1 wherein said rigid balls are from about 0.5 cm to about 5 cm in diameter.

7. The exercise garment of claim 1 wherein said rigid balls are from about 1 cm to about 3 cm in diameter.

8. The exercise garment of claim 1 wherein said support member has a longitudinal axis extending from said first end to said second end, and said compartments are sufficiently narrow in dimension parallel to said longitudinal axis that each compartment accommodates either a single said ball or a row of said balls one ball wide.

9. The exercise garment of claim 8 wherein said compartments are elongated compartments oriented transverse to said longitudinal axis, each compartment spanning at least one-half the width of said support member and containing a plurality of said balls in a row.
